(19) United States
(12) Patent Application Publication
(10) Pub. No.: US 2019/0061076 A1
(43) Pub. Date: Feb. 28, 2019

(54) MACHINE TOOL

(71) Applicant: DECKEL MAHO Seebach GmbH, Seebach (DE)

(72) Inventor: Fabian SUCKERT, Erfurt (DE)

(21) Appl. No.: 16/108,179

(22) Filed: Aug. 22, 2018

(30) Foreign Application Priority Data
Aug. 24, 2017 (DE) 10 2017 007 962.5

(51) Int. Cl. B23Q 1/01; B23Q 11/00; B23Q 11/10

(52) U.S. Cl. CPC B23Q 1/015; B23Q 11/10; B23Q 11/0042

(57) ABSTRACT

The present invention relates to a machine tool which has the following: a machine bed 10 which is supported on machine feet 3, 3a and is formed from a supporting structure of ribs which are connected to one another, wherein two guide rails 1 are arranged on the top side, on opposite outer sides of the machine bed 10, and a machine table 2 is provided between the two guide rails 1, wherein first main ribs 11 are provided on either side of the machine bed 10, the profile of the said first main ribs, in cross section of the machine bed 10, beginning below the guide rails 1 and extending obliquely inwards in the machine bed 10 to external machine feet 3a in order to introduce loads, which act on the guide rails 1, into the machine feet 3, 3a.

The present invention relates to a machine tool.

### BACKGROUND OF THE INVENTION

One of the most important constituent parts of a machine tool, besides the tool-supporting machining unit and the measurement systems used, is the machine bed. The machine bed has an important task in respect of the accuracy of the parts to be manufactured since it has to absorb the forces and loads which occur during the machining process by virtue of a corresponding rigidity. This applies particularly in the case of comparatively large machine tools in which high-volume components with a correspondingly high weight are processed. In this case, the higher the rigidity of the machine bed, the more accurate the result of the manufacture.

An inner support structure is generally provided in the machine bed for this purpose, the aim of the said inner support structure being to maximize the rigidity and at the same time to minimize the amount of material used for forming the machine bed. Furthermore, the support structure of the machine bed can have clearances and passages for lines or assemblies which are important for functioning.

A machine tool is known from EP 3 023 190 A1 and has vertically arranged supporting elements below the guide rails, so that extremely small movements of the side parts of the machine bed, which side parts support the guide rails, are avoided.

An important task of the machine bed is additionally that of directing the metal chips which are produced away from the working region of the machine tool.

Particularly in the case of large volumes of material which have to be removed from the workpiece, a correspondingly large amount of cooling lubricant together with the metal chips produced has to be reliably removed from the working region of the machine tool during machining of the workpiece and then conveyed out of the machine tool. If there is a build-up of metal chips on the workpiece, this can lead to undesired scratches being produced on the workpiece or even to more material than desired being removed from the workpiece (on account of the introduction of the metal chips into the removal process), and this can cause the manufacturing tolerances to vary greatly.

Combining the two requirements of achieving a high degree of rigidity of the machine bed and, at the same time, ensuring that large quantities of metal chips and/or cooling lubricant are carried away, can constitute a problem when designing and constructing the machine bed, and therefore compromises often have to be made.

### SUMMARY OF THE INVENTION

One object of the present invention is therefore to provide a machine tool with which the above problem can be avoided.

This object is achieved by a machine tool according to claim 1. The dependent claims relate to advantageous exemplary embodiments of the machine tool according to the invention.

The machine tool according to the invention has: a machine bed which is supported on machine feet and is formed from a supporting structure of ribs which are connected to one another, wherein two guide rails are arranged on the top side, on opposite outer sides of the machine bed, and a machine table is provided between the two guide rails, wherein first main ribs are provided on either side of the machine bed, the profile of the said first main ribs, in cross section of the machine bed, beginning below the guide rails and extending obliquely inwards in the machine bed to machine feet in order to introduce loads, which act on the guide rails, into the machine feet.

By virtue of the proposed arrangement of the first main ribs which extend obliquely inwards from the guide rails to the machine feet, the loads which act on the guide rails (for example mass of a portal which can be moved on the guide rails; machining forces which are produced on the portal by a machining device etc.) can be introduced into the machine feet in a direct load action line. This leads to an increased degree of rigidity of the machine tool.

The arrangement according to the invention of the ribs is particularly advantageous in respect of the stability and rigidity of the machine bed if the machine bed is installed on the substrate with a 3-point support. In this way, the high degrees of rigidity of the machine bed due to the ribbed portions are combined with the stable and easily adjustable setting up of a 3-point support, so that forces which occur during the machining process and/or loads, for example, of the workpiece to be processed are introduced into the substrate in an optimum manner. This is advantageous since only minimal deformations of the machine bed can occur on account of, for example, changing loads, wherein these deformations, however, cannot have a further effect on the stability of the machine bed.

In addition, by virtue of the proposed arrangement of the first main ribs, it is possible to ensure that the guide rails are at the greatest possible distance from one another (also called the guide carriage spacing). This distance depends on the size of the machine bed. Therefore, it is important that the guide rails are provided as close as possible to the edge of the machine bed in order to additionally maximize the rigidity of the respective machine tool by virtue of the greatest possible guide carriage spacing.

The machine bed is advantageously designed in such a way that the load introduction of the guide rails is separate from the load introduction of the machine table. This is facilitated by second main ribs which are arranged in the virtually direct load action line between machine table and the machine feet and in this case can additionally absorb lateral forces. This leads to there being no mutual influencing between the machining device (for example machining forces which are introduced into the machine bed by the guide rails and therefore influence the machine table) and the machine table (for example by the loads which are absorbed by the machine table and have an effect on the guide rails). As a result, a higher degree of accuracy of machining can be achieved.

In addition, a clearance which facilitates insertion of a device for transporting away material (for example metal chips, plastic chips or particles of other materials) which is produced during machining of the workpiece, is produced below the guide rails and close to the base by the proposed arrangement of the first and second main ribs. This has the critical advantage that the device for transporting away the metal chips is located close to the machine table and therefore the metal chips produced can be carried away from the working region of the machine tool relatively rapidly. This reduces the risk of a build-up of chips within the machine tool.

Furthermore, the required installation area of the machine tool can be considerably reduced by virtue of the insertion of the device for transporting away the metal chips since the device is “integrated” into the machine tool by virtue of the insertion into the machine bed. In addition to the technical advantage that the cooling lubricant can be reliably directed away and collected together with the metal chips below the machine table, the insertion of the device for transporting away the metal chips into the machine bed further provides a compact design of the machine tool.

A particularly advantageous development of the machine tool according to the invention is that second main ribs are provided on either side on the inside in relation to the first main ribs, the profile of the said second main ribs, in cross section of the machine bed, beginning below the machine table and extending obliquely outwards in the machine bed to the external machine feet in order to introduce loads, which act on the machine table, into the machine feet.

As a result, the load of the machine table can advantageously be introduced into the machine feet since the second main ribs are arranged in the virtually direct load action line between machine table and the machine feet. In addition, the second main ribs can absorb lateral forces which are produced, for example, by the machining of the workpiece which is mounted on the machine table.

A further advantageous development of the machine tool according to the invention is that the machine bed has a clearance laterally below the guide rails in the base region in each case, the said clearance being suitable for inserting a material-transporting device laterally beneath the machine bed.

On account of it being possible to insert the material-transporting device beneath the machine bed or into the machine bed, the cooling lubricant and metal chips which are produced and fall from the machine table can be reliably transported away and separated from one another, so that the metal chips can be disposed of (for example in special collection containers) and also the cooling lubricant which flows away from the machine table can be treated.

The machine tool according to the invention can be advantageously developed in that the material-transporting device can be inserted beneath the machine bed along an entire side length of the machine bed.

This has the advantage that metal chips and cooling lubricant can be collected and directed away not only within a limited region of the machine tool but rather along the entire length of the machine tool. This is therefore particularly advantageous since, during the machining of the workpiece, the metal chips and/or the cooling lubricant can be distributed throughout the working region of the machine and therefore the ability to collect and direct away metal chips and/or cooling lubricant should be ensured along the entire machine.

Furthermore, the machine tool according to the invention can be advantageously developed in that an outer side of the material-transporting device terminates substantially flush with a corresponding outer side of the machine bed after the insertion of the material-transporting device beneath the machine bed.

The advantage of this is that better safety for the machine operator at the machine tool can be achieved by the “integration” of the material-transporting device into the machine bed. Since a material-transporting device of this kind is otherwise usually installed in the immediate vicinity of the machine tool, there is always a risk of the machine operator being injured on or simply tripping over the said material-transporting device. In addition to the positive effect in respect of safety when using the machine tool, the “integration” of the material-transporting device into the machine bed also provides for a more compact design of the machine tool since the device now no longer needs to be installed directly next to the machine tool.

A particularly advantageous development of the machine tool according to the invention is that directing ribs are provided on either side in the machine bed, the profile of the said directing ribs, in cross section of the machine bed, beginning below an outer side of the machine table and extending obliquely outwards in the machine bed to the corresponding clearance in order to direct material falling from the machine table to the clearance, wherein the directing ribs are arranged laterally further to the outside than the second main ribs in the machine bed.

The directing ribs can particularly advantageously direct the metal chips or the cooling lubricant, which fall from or flows beneath the machine table, to the corresponding clearance in which, for example, a material-transporting device is provided.

The machine tool according to the invention can advantageously be developed in that the first main ribs have a large number of passage openings which are provided periodically, wherein the material on the directing ribs is directed through the passage openings to the respective clearance.

In addition, it is advantageous when the first main ribs have passage openings which are arranged periodically and through which metal chips and/or cooling lubricant can be directed from the machine table to the corresponding clearance on the respective directing ribs. Therefore, a load of the guide rails can be advantageously absorbed by the machine feet and at the same time material (for example metal chips, cooling lubricant etc.) which is produced can be directed from the machine table, which is provided on the machine bed, to the respective clearance by means of the directing ribs.

Furthermore, the machine tool according to the invention can be advantageously developed in that the material-transporting device is a chain-type and/or spiral-type chip conveyor.

The material-transporting device is not restricted to chain-type and/or spiral-type chip conveyors here. Instead, the two embodiments are intended to serve merely as examples. Any other type of material-transporting device can of course likewise be inserted beneath or into the machine bed.

A further advantageous development of the machine tool according to the invention is that the machine tool has a portal which supports a machining device, having two stands and a crossbar which is supported by the stands, wherein the stands can be moved beyond the machine table on the guide rails.

A further advantageous development of the machine tool according to the invention is that the machining device which is supported by the crossmember can be moved by means of two linear spindles, wherein the two linear spindles are arranged both perpendicular to one another and also perpendicular to the guide path of the guide rails.

As a result, the machining device (for example a working spindle or another material-removing device) can be moved at least along the three spatial directions. Furthermore, the machine tool could advantageously be developed, for example, such that the position of the machine table in relation to the machining device could additionally be changed through one, two or further axes, similarly to the manner known from rotary or pivoting tables.

Owing to the arrangement of the first and second main ribs according to the machine tool according to the invention, the rigidity of the machine tool could be increased in a simple manner. In addition, a clearance could be created in the vicinity of the base by virtue of the arrangement, the said clearance facilitating, for example, insertion of a chip conveyor into or beneath the machine bed and therefore firstly ensuring that metal chips and/or cooling lubricant are transported away in a rapid and reliable manner and at the same time reducing the required installation area of the machine tool.

Further aspects and the advantages thereof and also advantages and more specific possible embodiments of the above-described aspects and features are described in the following descriptions and explanations of the appended figures, which descriptions and explanations are not to be considered restrictive in any way.

### BRIEF DESCRIPTION OF THE FIGURES

FIG. 1 schematically shows a cross section through an embodiment of a machine tool according to the invention, comprising first and second main ribs and directing ribs;

FIG. 2 schematically shows a three-dimensional view of a sectional illustration of an embodiment of the machine tool according to the invention, comprising visible passage openings in the first main rib; and

FIG. 3 schematically shows an enlarged detail of a sectional illustration of a front view of an embodiment of the machine tool according to the invention.

### DETAILED DESCRIPTION OF THE FIGURES AND PREFERRED EXEMPLARY EMBODIMENTS OF THE PRESENT INVENTION

Examples and exemplary embodiments of the present invention will be described in detail below with reference to the appended figures. Identical or similar elements in the figures can be denoted by the same reference symbols here.

It should be noted however that the present invention is in no way limited or restricted to the exemplary embodiments described below and the design features thereof, but rather furthermore includes modifications to the exemplary embodiments, in particular those which are included by modifying the features of the described examples or by combining individual features or several of the features of the described examples within the scope of protection of the independent claims.

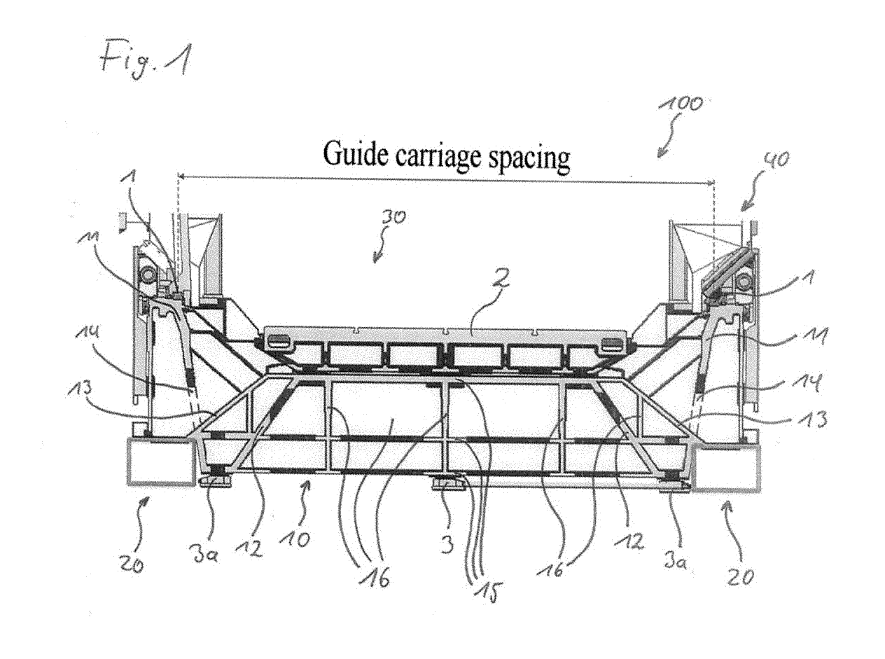

FIG. 1 schematically shows an embodiment of a machine tool 100 according to the invention, comprising first and second main ribs 11, 12 and directing ribs 13 which are provided as a supporting structure in a machine bed 10 of the machine tool 100.

In this case, the machine bed 10 is installed on a large number of machine feet 3, 3a which support the entire load of the machine tool 100 including a clamped-in workpiece. The support structure, which is intended to provide a corresponding supporting load and rigidity to the machine bed 10, is constructed in such a way that the first main ribs 11 extend from the guide rails 1 to the machine feet (here the machine feet 3a which span a footprint of the machine tool 100), wherein the first main ribs 11 run obliquely inwards in the machine bed 10 since the machine feet 3a which are arranged furthest to the outside are arranged further to the inside in relation to the machine bed 10 than the guide rails 1 which are provided on the top side of the machine bed 10.

Two advantages are achieved as a result: firstly, the rigidity of a device (for example a portal 40 which supports a working spindle) which can be moved on the guide rails 1 is increased since the distance between the guide rails 1 corresponds approximately to the width of the machine bed 10 and therefore a maximum possible guide carriage spacing (distance between the guide rails 1, identified in FIG. 1) can be ensured. Secondly, a clearance 20 is created through the first main ribs 11 which run inwards in the direction of the machine feet 3a, the said clearance being located below the guide rails 1 and in the vicinity of the base and it being possible to use the said clearance for inserting a material-transporting device (for example a chain-type and/or spiral-type chip conveyor 21; not shown in FIG. 1 but merely indicated by the rectangles in the bottom left and bottom right corners of the machine bed 10).

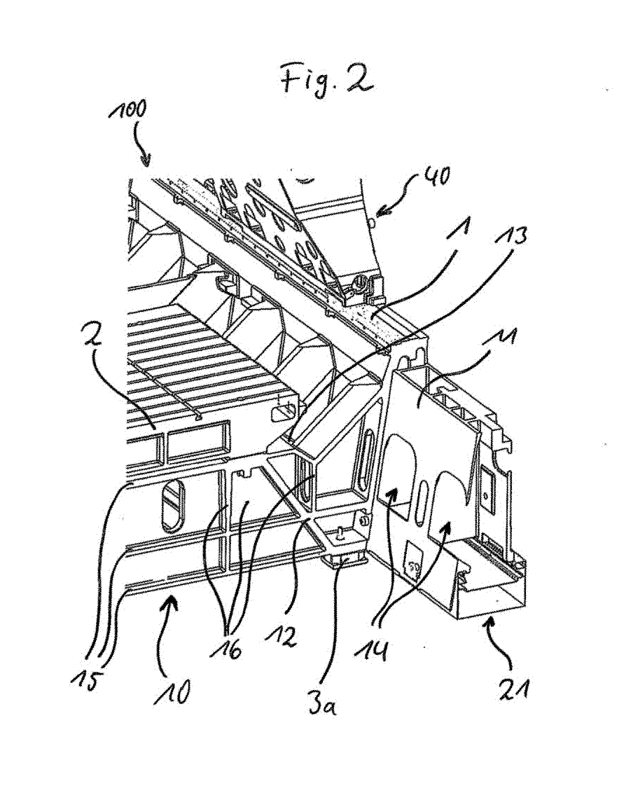

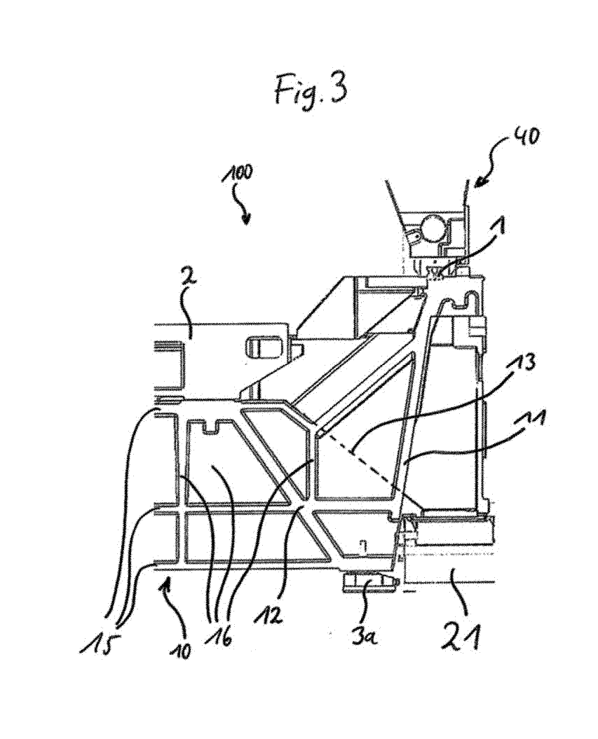

The insertion of the chip conveyor 21 (not shown in FIG. 1; see FIGS. 2 and 3) beneath or into the machine bed 10 provides further advantages. The chip conveyor 21 can therefore be provided closer to the machine table 2 of the machine tool 100, so that metal chips (or particles of another material) and/or cooling lubricant can be carried away from the machine tool 100, in particular from the working region 30, in a relatively rapid and reliable manner.

In addition, the chip conveyor 21 can be inserted beneath or into the machine bed 10 in such a way that it terminates flush with an outer face of the machine tool 100, so that the machine bed 10 substantially has a rectangular outer contour (as viewed in cross section). In addition to a more compact design of the machine tool 100, this also provides increased safety for the machine operator since fewer assemblies and apparatuses on which the machine operator can injure himself or over which said machine operator can trip are arranged on the or around the machine tool 100.

The directing ribs 13 are a further element in the support structure of the machine bed 10. The said directing ribs direct metal chips and/or cooling lubricant which fall from or flows beneath the machine table 2 to the corresponding clearance 20 comprising the inserted chip conveyor 21 (not shown in FIG. 1; see FIGS. 2 and 3).

In this case, the directing ribs 13 are positioned at a steep angle in such a way that metal chips falling from the machine table 2 slide across the directing ribs 13 to the chip conveyor 21 without an additional apparatus. On account of the arrangement of the rib portions and of the chip conveyor 21, the metal chips and also the cooling lubricant have/has to be directed through the first main ribs 11. However, this is possible since the first main ribs 11 have a large number of passage openings 14 which are usually arranged periodically. However, the distances between the passage openings 14 can also have deviations. This may be necessary, for example, when further elements of the support structure of the machine bed 10 do not permit a periodic arrangement of the passage openings 14.

The second main ribs 12 are a further essential element in the support structure of the machine bed 10. The said second main ribs run below the outer region of the machine table 2 obliquely outwards to the machine feet 3a. In this case, the said second main ribs are able both to absorb the load of the machine table 2 and of a clamped-in workpiece and to introduce the said load into the machine feet 3a and also to reliably introduce lateral forces from the machine table 2, which occur during machining of the workpiece, into the machine feet 3a and in this way to minimize the influence of these forces on the surrounding support structure.

The arrangement of the first main ribs 11 and second main ribs 12 forms a special feature of the support structure of the machine bed 10. The said first main ribs and second main ribs are formed in a V shape in relation to one another. This leads to the mutual influencing of the first main ribs 11, which absorb the loads and forces of the guide rails 1, and the second main ribs 12, which absorb the forces and loads of the machine table 2, being limited to a minimum.

This is particularly advantageous since the forces which are produced are primarily variable forces (for example variable mass/masses of the workpiece, continuously changing lateral forces during machining of the workpiece etc.). These forces are variable over time and can therefore be monitored and possibly compensated for only with a high degree of complexity (for example a large number of further position measuring systems etc.) during the machining process. It is therefore advantageous to keep the mutual influencing of the machine table 2 and machining device (for example working spindle on a portal 40) as small as possible from the start on account of the forces which occur.

Furthermore, it is advantageous when the machine tool 100 according to the invention is installed on a 3-point support which is formed by the machine feet 3, 3a.

In this way, the high degrees of rigidity of the machine bed 10 on account of the first and second main ribs 11, 12 are combined with the stability and easy adjustability of a 3-point support. As a result, forces which occur during the machining process and/or loads, for example, of the workpiece to be processed can be introduced into the substrate in an optimum manner.

In addition, this is advantageous since only minimal deformations of the machine bed 10 can occur on account of, for example, variable loads, wherein these deformations, however, cannot have a further effect on the stability of the machine bed 10. Precision in respect of machining of a workpiece can be improved in this way.

In addition, individual machine feet 3, 3a can be designed in a fixed/loose bearing combination in order to not cause any deformations by clamping of the machine bed 10, for example in the case of thermal expansions of the machine bed 10. This can additionally increase the precision in respect of machining of a workpiece.

In addition to the first and second main ribs 11, 12, the support structure also has a large number of horizontal ribs 15 and vertical ribs 16 which, in interaction with the first and second main ribs 11, 12 and also the directing ribs 13, increase the rigidity of the machine bed 10 overall or provide the support structure with the correspondingly required or desired rigidity.

However, in addition to the mentioned ribbed portions, the support structure can also have further ribs, which run obliquely between the horizontal and vertical ribs 15, 16 for example, in order to increase the rigidity of the machine bed 10.

FIG. 2 schematically shows a three-dimensional view of a sectional illustration of an embodiment of the machine tool 100 according to the invention, comprising visible passage openings 14 in the first main rib 11.

Here, in the side region of the machine tool 100, amongst other things, one of the first main ribs 11, comprising passage openings 14, and also a chip conveyor 21 (for example a chain-type chip conveyor) are illustrated in a manner projecting from the rest of the machine bed 10.

The passage openings 14 which are now identifiable are designed in such a way that they have an arcuate contour or two rounded corner regions in their upper region, so that their upper region has a bridge-like form. This has the advantage that the first main ribs 11 are of more rigid design in the longitudinal direction, that is to say in the direction of the guide path of the guide rails 1 (on which, for example, a portal 40 with a machining device can be moved), and as a result can absorb higher forces which act along the longitudinal direction. These forces can now be directly introduced into the machine feet 3, 3a, without the second main ribs 12 and accordingly the support structure below the machine table 2 being excessively severely influenced in the process.

At the same time, the bridge-like form of the upper region of the passage openings 14 facilitates the formation of large passage openings 14. This provides the advantage of providing both a high degree of rigidity in the machine bed 10 and at the same time reliably ensuring that material (for example metal chips etc.) which are produced and/or cooling lubricant are/is rapidly transported away.

The metal chips and/or the cooling lubricant which fall from and, respectively, flows downwards from the machine table 2 are fed to the chip conveyor 21 by means of the directing ribs 13. The said chip conveyor can now convey the metal chips and/or the cooling lubricant out of the machine tool 100 or, depending on the design of the chip conveyor 21, equally separate metal chips and cooling lubricant. This may be advantageous in order to firstly ensure disposal of the metal chips and at the same time to rapidly feed the cooling lubricant to a means for further treatment.

Furthermore, FIG. 2 shows a corresponding three-dimensional view of the horizontal and vertical ribs 15, 16.

FIG. 3 schematically shows an enlarged detail of a sectional illustration of a front view of an embodiment of the machine tool 100 according to the invention indicating the profile of the directing ribs 13 (dashed line).

The said figure shows how material (for example metal chips) falling from the machine table 2 or cooling lubricant flowing away from the said machine table is directed on the surface of the directing rib 13 to the clearance or to the chip conveyor 21. Here, the directing rib 13 is positioned at a steep angle in such a way that the falling material and/or the cooling lubricant flowing downwards can slide or flow from the machine table 2 in the direction of the chip conveyor 21 without additional apparatuses.

Furthermore, the profile of the first and second main ribs 11, 12 in the machine bed 10 is very clearly shown, and therefore the first main rib 11 and the second main rib 12 have a V-shaped arrangement in relation to one another and meet at the point of the machine foot 3a. This advantageously reduces the mutual influencing of the first and second main ribs 11, 12 by the respective, variable loads and forces. The accuracy of the machine tool 100 could be effectively increased in this way.

Furthermore, FIG. 3 once again shows the arrangement of the guide rails 1 and of a portal 40 which can be moved on the guide rails 1, and also a corresponding front view of the horizontal and vertical ribs 15, 16.

### LIST OF REFERENCE SYMBOLS

1 Guide rail
2 Machine table
3, 3a Machine foot
10 Machine bed
11 First main rib
12 Second main rib
13 Directing rib
14 Passage opening
15 Horizontal rib
16 Vertical rib
20 Clearance
21 Chip conveyor
30 Working region
40 Portal
100 Machine tool

1. Machine tool, comprising:
a machine bed which is supported on machine feet and is formed from a supporting structure of ribs which are connected to one another, wherein two guide rails are arranged on the top side, on opposite outer sides of the machine bed, and a machine table is provided between the two guide rails,
characterized in that
first main ribs are provided on either side of the machine bed, the profile of the said first main ribs, in cross section of the machine bed, beginning below the guide rails and extending obliquely inwards in the machine bed to machine feet in order to introduce loads, which act on the guide rails, into the machine feet.

2. Machine tool according to claim 1, characterized in that
second main ribs are provided on either side on the inside in relation to the first main ribs, the profile of the said second main ribs, in cross section of the machine bed, beginning below the machine table and extending obliquely outwards in the machine bed to the external machine feet in order to introduce loads, which act on the machine table, into the machine feet.

3. Machine tool according to claim 1, characterized in that
the machine bed has a clearance laterally below the guide rails in the base region in each case, the said clearance being suitable for inserting a material-transporting device laterally beneath the machine bed.

4. Machine tool according to claim 3, characterized in that
the material-transporting device can be inserted beneath the machine bed along an entire side length of the machine bed.

5. Machine tool according to claim 3, characterized in that
an outer side of the material-transporting device terminates substantially flush with a corresponding outer side of the machine bed after the insertion of the material-transporting device beneath the machine bed.

6. Machine tool according to claim 3, characterized in that
directing ribs are provided on either side in the machine bed, the profile of the said directing ribs, in cross section of the machine bed, beginning below an outer side of the machine table and extending obliquely outwards in the machine bed to the corresponding clearance in order to direct material falling from the machine table to the clearance, wherein
the directing ribs are arranged laterally further to the outside than the second main ribs in the machine bed.

7. Machine tool according to claim 6, characterized in that
the first main ribs have a large number of passage openings which are provided periodically, wherein the material on the directing ribs is directed through the passage openings to the respective clearance.

8. Machine tool according to claim 3, characterized in that
the material-transporting device is a chain-type and/or spiral-type chip conveyor.

9. Machine tool according to claim 1, characterized in that
the machine tool has a portal which supports a machining device, having two stands and a crossbar which is supported by the stands, wherein the stands can be moved beyond the machine table on the guide rails.

10. Machine tool according to claim 9, characterized in that
the machining device which is supported by the crossmember can be moved by means of two linear spindles, wherein the two linear spindles are arranged both perpendicular to one another and also perpendicular to the guide path of the guide rails.
